(19) United States
(12) Patent Application Publication
(10) Pub. No.: US 2014/0162728 A1
(43) Pub. Date: Jun. 12, 2014

(54) SYSTEM AND METHOD FOR PHONE NUMBER PREFIX ENTRY

(71) Applicants: Oleg Khokhlov, Moscow (RU); Evgeniy Kazban, Simferepol (UA)

(72) Inventors: Oleg Khokhlov, Moscow (RU); Evgeniy Kazban, Simferepol (UA)

(21) Appl. No.: 14/099,878

(22) Filed: Dec. 6, 2013

Related U.S. Application Data
(60) Provisional application No. 61/733,899, filed on Dec. 6, 2012.

(51) Int. Cl. H04W 4/16

(52) U.S. Cl. CPC H04W 4/16
USPC 455/564

(57) ABSTRACT

Systems and methods for prepending prefixes to partial phone numbers may be executed by a mobile device and may include the steps of: receiving a partial phone number as input from a user; displaying a plurality of prefixes; receiving a selection of one of the prefixes from the user; prepending the selected prefix to the partial phone number; and completing a dialing process with the selected prefix prepended to the partial phone number. The plurality of prefixes may be selected based on their likelihood of selection by the user, wherein the likelihood of selection by the user is determined, at least in part, by one or more of: prefixes included in contact information stored in the mobile phone; statistics of the dialing history of the mobile phone; the location of the mobile phone; and a list of prefixes provided by the user of the mobile phone.

### BACKGROUND OF THE INVENTION

The present subject matter relates generally to systems and methods for phone number prefix entry. More specifically, the present subject matter provides systems and methods in which a one or more prefixes may be added to a partial phone number prior to completing the dialing process.

When dialing within the U.S., telephone numbers may include up to ten digits plus any local extension number. The first digit is the long distance code (e.g., in the U.S., the long distance code is “1”), the following three digits are the area code (e.g., in downtown Chicago, the area code may be “312”), the next three digits are the exchange code and the last four digits are the local number. When dialing internationally, telephone numbers further include an exit code (e.g., in the U.S., the exit code is “011”) and a country code (e.g., to dial Russia, the country code is “7”).

In certain instances, a user may have access to, or may know, only a portion of a phone number, but not the appropriate prefix. For example, in some situations, a user may know the exchange code and local number (i.e., the last seven digits of the phone number), but not the area code. In certain metropolitan areas, there may be a number of area codes that cover adjacent and/or overlapping areas. Accordingly, it may not be immediately apparent which area code may apply.

Similarly, when dialing internationally, one may know a portion of the phone number, including the area code, exchange code, and local number, but may not remember (or know) the country code and/or exit code.

Prior to the subject matter disclosed herein, there weren't systems and methods for easily attaching a prefix into a partial phone number. Accordingly, there is a need for systems and methods in which a one or more prefixes may be added to a partial phone number prior to completing the dialing process, as described herein.

### BRIEF SUMMARY OF THE INVENTION

To meet the needs described above and others, the present disclosure provides systems and methods in which one or more prefixes may be added to a partial phone number prior to completing the dialing process. The systems and methods may be employed in mobile devices, such as mobile phones, or in other systems that include a dialing application.

In one example, the system is embodied in a mobile application resident in a mobile device, such as a mobile phone. The application integrates with the resident dialing application and allows a user to automatically insert a prefix into a partial phone number prior to dialing by making a selection from a plurality of listed prefixes. In one example, a selection of a prefix may be made using an input button, such as a volume button. In another example, the user may select one of the listed prefixes using a touch screen selection. Any number of alternative input mechanisms may be used to make the user selection of the prefix, including audio input, such as through voice recognition.

In one example, the method includes the steps of: receiving, in a mobile device, a partial phone number as input from a user while the mobile device is in dialing mode; displaying a plurality of telephone number prefixes in response to the input from the user; receiving a selection of one of the prefixes from the user; adding the prefix into the partial phone number prior to dialing.

In some embodiments, the plurality of prefixes is determined by using available information suggesting their likelihood of selection by the user. For example, the available information can comprise prefix statistics of the mobile device's contact list. As another example, the available information can comprise prefix statistics of the dialing history of the mobile device. As a further example, the available information can comprise prefix statistics based on the location of the mobile device using GPS or other geo-location technologies. Additionally, the available information comprises a list of prefixes provided by the user of the mobile device. Further, the available information can comprise any combination of the previous sources of available information.

In some embodiments, some or all of the plurality of prefixes comprises a set of digits less than the length of a full telephone number. For example, some or all of the plurality of prefixes could comprise an exit code, country code, and an area code. As a further example, some or all of the plurality of prefixes comprise an exit code, a country code, an area code, and an exchange code. In other examples, the plurality of prefixes may be area codes.

One of the selections a user may make is to control the number of prefixes displayed from which a selection is to be made. For example, in some embodiments, the user may select whether one or two lines of possible prefixes are displayed.

In an example of the systems and methods in use, a user may know a seven-digit phone number, but not the associated area code. In such a case, the user may open the resident dialing application on the mobile phone, dial the seven-digit number, and be presented with a plurality of area codes from which to make a selection. The area codes presented to the user may be selected, for example, based on a statistical analysis of a combination of the user's stored contact information combined with location-based information identifying the location of the mobile phone. The user may then make a selection of one of the plurality of prefixes by scrolling through the prefixes using the “volume up” button and making a selection of one of the prefixes using the “volume down” button. Upon making a selection, the mobile phone may prepend the prefix to the seven-digit number and execute the completion of the dialing routine.

An example of a method based on the subject matter provided herein includes the steps of: while the mobile device is in dialing mode, receiving a partial phone number as input from a user; in response to receiving the partial phone number, displaying a plurality of prefixes; receiving a selection of one of the prefixes from the user; prepending the selected prefix to the partial phone number; and completing a dialing process with the selected prefix prepended to the partial phone number entered by the user.

In another example, a system for prepending one or more prefixes to a partial phone number prior to dialing includes: a mobile phone including a dialing application; a first user input through which a user inputs a partial telephone number; a prefix prepending application that displays a plurality of prefixes that may be prepended to the partial telephone number; and a second user input through which a user selects one of the plurality of prefixes to be prepended to the partial telephone number.

In yet another example, a phone dialing system includes: a mobile phone including a processor; and a memory in communication with the processor, including stored instructions that, when executed by the processor, cause it to perform the steps of: provide a dialing mode that accepts a partial phone number as input from a user; receive the partial phone number as input from a user; in response to receiving the partial phone number, display a plurality of prefixes; receive a selection of one of the prefixes from the user; prepend the selected prefix to the partial phone number; and complete a dialing process with the selected prefix prepended to the partial phone number entered by the user.

In the various examples of systems and methods, the specific prefixes included in the plurality of prefixes are selected based on their likelihood of selection by the user. The likelihood of selection by the user may be determined, at least in part, by prefixes included in contact information stored in the mobile device. The likelihood of selection by the user may be determined, at least in part, statistics of the dialing history of the mobile device. The likelihood of selection by the user may be determined, at least in part, by the location of the mobile device. The likelihood of selection by the user may be determined, at least in part, a list of prefixes provided by the user of the mobile device.

The prefixes may include any combination of exit codes, country codes, area codes and exchange codes. In some example, all of the prefixes provided to the user include only one type the code. In other examples, the user may be presented with a combination of various codes of different configurations.

An object of the invention is to streamline manual entry of ten digit (or greater) phone numbers.

Another object of the invention is to provide the most statistically likely prefix number to be prepended to a partial phone number.

Another advantage of the invention is that it requires minimal configuration from the user.

A further advantage of the invention is that it may be integrated with an existing mobile device dialing application.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is an example of a system in which a one or more prefixes may be added to a partial phone number prior to completing the dialing process.

FIG. 2 is an example of a method in which a one or more prefixes may be added to a partial phone number prior to completing the dialing process.

FIG. 3 is a schematic block diagram representation of a mobile device in which the disclosed systems and methods may be embodied.

### DETAILED DESCRIPTION OF THE INVENTION

The present disclosure provides phone prefix prepending systems and methods in which a one or more prefixes may be added to a partial phone number prior to completing the dialing process. The systems and methods presented herein may be embodied in a phone dialing application resident in a mobile device such as a mobile phone. Further, the systems and methods presented herein may be implemented by way of a separate application or integrated with the operating system of the mobile phone or other electronic communication device.

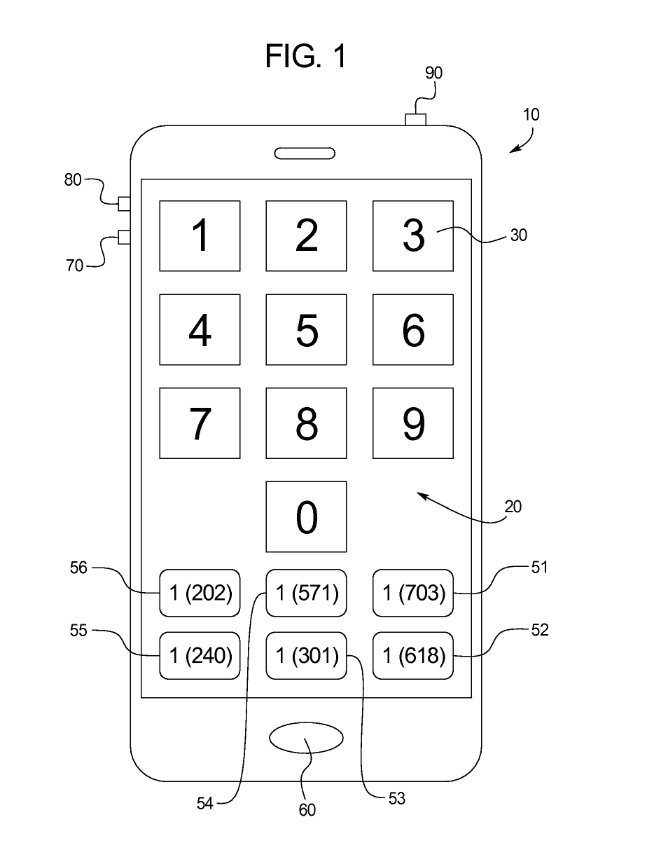

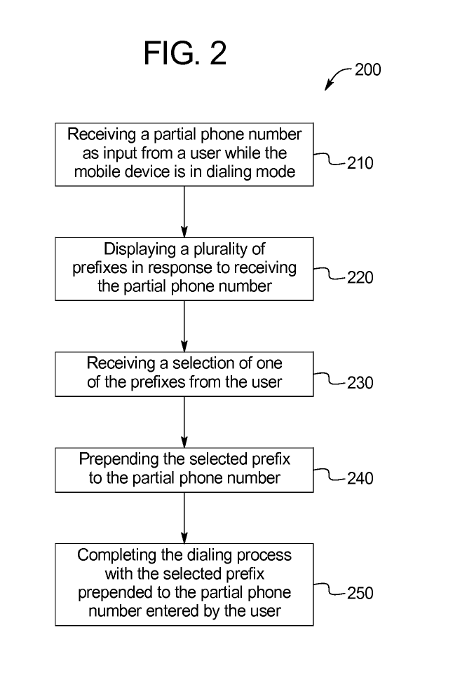

FIG. 1 illustrates an example of a mobile device 10 adapted to prepend one or more prefixes to a partial phone number prior to completing the dialing process. As shown in FIG. 1, the mobile device 10 includes a first user input, embodied in a touch screen 20. In dialing mode, the touch screen 20 is capable of displaying a virtual keypad 30 capable of receiving input from the user. The mobile device 10 also includes additional user inputs, embodied in multifunction buttons 60, 70, 80, and 90. As will be recognized by those skilled in the art, the multifunction physical buttons 60, 70, 80, and 90 may commonly be used as selection controls, volume controls, power controls, etc. In the examples provided herein, the multifunction physical buttons 60, 70, 80, and 90 may be configured to bring up and select from prefix options as described further herein. In FIG. 1, the prefix options are presented as prefix buttons 51-56. The elements shown in FIG. 1 provide context for the methods described with respect to FIG. 2.

FIG. 2 illustrates a method 200, executed by a mobile device 10, of to prepending one or more prefixes to a partial phone number prior to dialing including the steps of: while the mobile device 10 is in dialing mode, receiving a partial phone number as input from a user (step 210); in response to receiving the partial phone number, displaying a plurality of prefixes 51-56 (step 220); receiving a selection of one of the prefixes 51-56 from the user (step 230); prepending the selected prefix to the partial phone number (step 240); and completing the dialing process with the selected prefix prepended to the partial phone number entered by the user (step 250).

The input of the partial phone number in step 210 may be accomplished by the user using any input mechanism enabled by the mobile device 10. For example, by pressing any physical or virtual numerical or non-numerical button of the mobile device 10. The input may also be accomplished by a user voice command. For example, the user may make an input by pressing a predetermined button out of the group of multifunction physical buttons 60, 70, 80, and 90. Alternatively, the user may make an input by pressing a virtual button or performing a gesture on the touch screen 20. Of course, numerous other forms of inputting information into a mobile device may be used to bring up the prefix selection, as will be recognized by those skilled in the art.

The plurality of area code prefixes may be displayed in any form permitting the user to make a choice between the prefixes. For example, the plurality of area code prefixes can be a group of virtual buttons 51-56 that may be selected by touch. Alternatively, the plurality of area code prefixes can be displayed as a list that may be selected by touch or by pressing a predetermined button out of the group of the multifunction physical buttons 60, 70, 80, and 90. For example, physical button 80 may be used to scroll through the list prefixes 51-56 and physical button 70 may be used to make a selection from the list of prefixes 51-56. Those skilled in the art will recognize numerous other usable combinations of physical buttons, virtual buttons, gestures and voice commands to indicate a selection from the list. Furthermore, those skilled in the art will recognize numerous alternatives for displaying the plurality of area code prefixes in any form permitting the user to make a choice between the prefixes.

The plurality of area code prefixes 51-56 may be of any length likely to useful to the user in inputting a telephone number, generally a number of digits less than the length of a full telephone number. For example, some or all of the plurality of prefixes can comprise a country code and an area code as shown by the prefix buttons 51-56 in FIG. 1. As another example, some or all of the plurality of prefixes can comprise an exit code, a country code, an area code, and an exchange code. Furthermore, those skilled in the art will recognize numerous alternatives for choosing a prefix length likely to be useful to the user in inputting a telephone number.

The plurality of area code prefixes 51-56 displayed may be chosen based on their likelihood of selection by the user. The mobile device 10 may chose the plurality of phone number prefixes 51-56 without requiring any intervening user indication of which prefixes to display. For example, the plurality of prefixes 51-56 can be chosen through statistical analysis of the mobile device's contact list regarding the most common prefixes of contacts present in the list. The mobile device 10 can periodically populate the list of common prefixes in the contact list, or can populate the list upon launching of the dialing mode. Additionally, the plurality of prefixes 51-56 can be chosen by statistically analyzing the dialing history of the mobile device 10. Alternatively, the plurality of prefixes 51-56 can be chose by defining the location of the mobile device 10 based on GPS and/or cellular tower triangulation and choosing prefixes of the surrounding region. For example, using the GPS location, the mobile phone 10 can determine the area code prefix of the location of the mobile device 10 and surrounding regions using a database stored in memory or by accessing a remote database. Furthermore, the plurality of prefixes 51-56 can be chosen by permitting the user of the mobile device 10 to define a list of preferred prefixes. Finally, the plurality of prefixes 51-56 can by chosen by a combination of the previous methods of choosing the plurality of prefixes 51-56 or by numerous known substitutes as will be recognized by those skilled in the art. Those skilled in the art will also recognize numerous alternatives for determining the most likely prefixes 51-56 for the user to input.

For example, the plurality of prefixes 51-56 presented to the user includes a combination of prefixes 51-56 determined from varied methods. In one example, one of the plurality of prefixes 51-56 include at least one prefix 51-56 determined by the prefixes included in contact information stored in the mobile phone and at least one prefix 51-56 determined by the location of the mobile phone. For example, six prefixes 51-56 may be presented to the user, including two prefixes 51-56 determined using the location of the mobile device 10 and four prefixes 51-56 determined by selecting the four most common prefixes 51-56 stored in the mobile device's contact data.

Similarly, the plurality of prefixes 51-56 may include any combination of exit codes, country codes, area codes, and exchange codes. For example, in instances in which six prefixes 51-56 are presented to the user, three of the prefixes 51-56 may include an exit code and country code and another three of the prefixes 51-56 may include area codes.

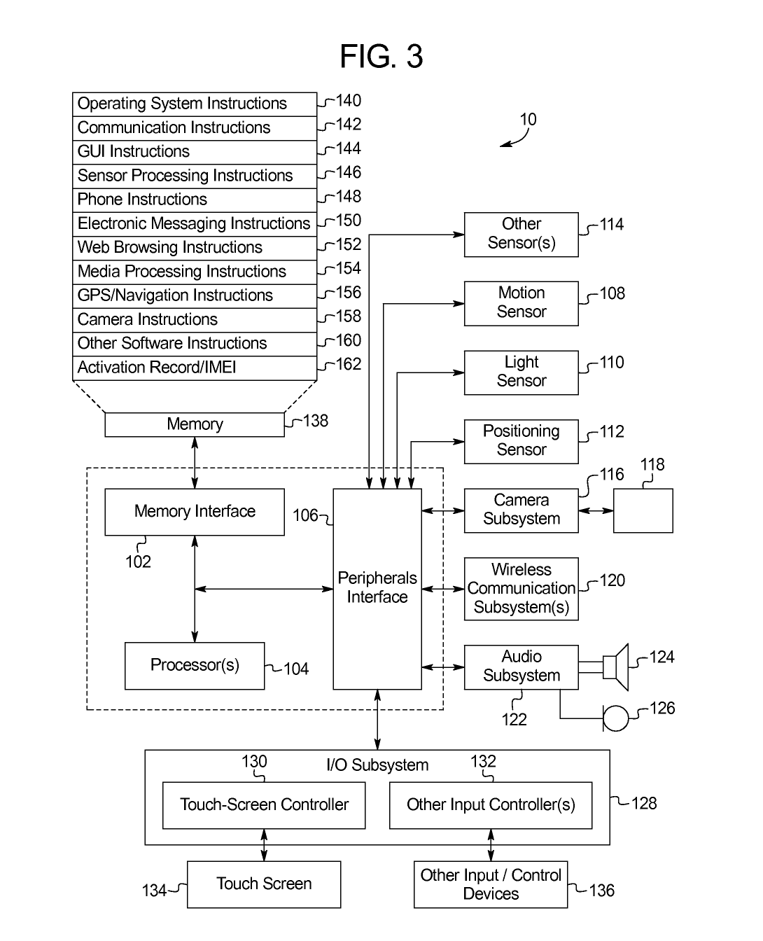

FIG. 3 is a block diagram representation of an example implementation of a mobile device 10. Referring to FIG. 1, the mobile device 10 includes a memory interface 102, one or more data processors, image processors and/or central processors 104, and a peripherals interface 106. The memory interface 102, the one or more processors 104 and/or the peripherals interface 106 can be separate components or can be integrated in one or more integrated circuits. The various components in the mobile device 10 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the mobile device 10 is intended to operate. For example, the mobile device 10 can include communication subsystems 120 designed to operate over a GSM network, a GPRS network, an EDGE network, a Wi-Fi or WiMax network, and a Bluetooth™ network. In particular, the wireless communication subsystems 120 may include hosting protocols such that the mobile device 10 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a touch screen 134. The touch screen 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the mobile device 10 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the mobile device 10 may be implemented in hardware and/or in software, including in one or more signal processing and/or application specific integrated circuits. Accordingly, the mobile device 10, as shown in FIG. 3, may be adapted to perform any combination of the functionality described herein.

It should be noted that various changes and modifications to the presently preferred embodiments described herein will be apparent to those skilled in the art. Such changes and modifications may be made without departing from the spirit and scope of the present invention and without diminishing its attendant advantages.

What is claimed is:

1. A method, executed by a mobile device, comprising the steps of:
while the mobile device is in dialing mode, receiving a partial phone number as input from a user;
in response to receiving the partial phone number, displaying a plurality of prefixes;
receiving a selection of one of the prefixes from the user;
prepending the selected prefix to the partial phone number; and
completing a dialing process with the selected prefix prepended to the partial phone number entered by the user.

2. The method of claim 1, wherein the prefixes included in the plurality of prefixes are selected based on their likelihood of selection by the user.

3. The method of claim 2, wherein the likelihood of selection by the user is determined, at least in part, by prefixes included in contact information stored in the mobile device.

4. The method of claim 2, wherein the likelihood of selection by the user is determined, at least in part, by statistics of the dialing history of the mobile device.

5. The method of claim 2, wherein the likelihood of selection by the user is determined, at least in part, by the location of the mobile device.

6. The method of claim 2, wherein the wherein the likelihood of selection by the user is determined, at least in part, by a list of prefixes provided by the user of the mobile device.

7. The method of claim 1, wherein the prefixes include area codes.

8. The method of claim 1, wherein the prefixes include country codes and area codes.

9. The method of claim 1, wherein the prefixes include exit codes, country codes and area codes.

10. The method of claim 1, wherein the prefixes include exit codes, country codes, area codes and exchange codes.

11. A system for prepending one or more prefixes to a partial phone number prior to dialing comprising:
a mobile phone including a dialing application;
a first user input through which a user inputs a partial telephone number;
a prefix prepending application that displays a plurality of prefixes that may be prepended to the partial telephone number; and
a second user input through which a user selects one of the plurality of prefixes to be prepended to the partial telephone number.

12. The system of claim 11, wherein the prefixes included in the plurality of prefixes are selected based on their likelihood of selection by the user.

13. The system of claim 12, wherein the likelihood of selection by the user is determined, at least in part, by prefixes included in contact information stored in the mobile phone.

14. The system of claim 12, wherein the likelihood of selection by the user is determined, at least in part, by statistics of the dialing history of the mobile phone.

15. The system of claim 12, wherein the likelihood of selection by the user is determined, at least in part, by the location of the mobile phone.

16. The system of claim 12, wherein the wherein the likelihood of selection by the user is determined, at least in part, by a list of prefixes provided by the user of the mobile phone.

17. The system of claim 11, wherein the prefixes include any combination of exit codes, country codes, area codes and exchange codes.

18. A phone dialing system comprising:
a mobile phone including a processor; and
a memory in communication with the processor, including stored instructions that, when executed by the processor, cause it to perform the steps of:
provide a dialing mode that accepts a partial phone number as input from a user;
receive the partial phone number as input from a user;
in response to receiving the partial phone number, display a plurality of prefixes;
receive a selection of one of the prefixes from the user;
prepend the selected prefix to the partial phone number; and
complete a dialing process with the selected prefix prepended to the partial phone number entered by the user.

19. The system of claim 18 wherein the prefixes included in the plurality of prefixes are selected based on their likelihood of selection by the user, wherein the likelihood of selection by the user is determined, at least in part, by one or more of:
prefixes included in contact information stored in the mobile phone;
statistics of the dialing history of the mobile phone;
the location of the mobile phone; and
a list of prefixes provided by the user of the mobile phone.

20. The system of claim 18 wherein the prefixes include any combination of exit codes, country codes, area codes, and exchange codes.
